(19) United States
(12) Patent Application Publication
(10) Pub. No.: US 2006/0086585 A1
(43) Pub. Date: Apr. 27, 2006

(54) Device for transmitting the rotating movement to a driven shaft, in particular for fluid recirculating pumps

(75) Inventor: Piercarlo Boffelli, Milano (IT)

Correspondence Address: SEYFARTH SHAW LLP, 55 E. MONROE STREET, SUITE 4200, CHICAGO, IL, 60603-5803, US

(73) Assignee: Baruffaldi S.p.A.

(21) Appl. No.: 11/255,300

(22) Filed: Oct. 21, 2005

(30) Foreign Application Priority Data
Oct. 26, 2004 (IT) MI2004U 000584

(51) Int. Cl. F16D 27/00

(52) U.S. Cl. 192/84.31; 192/84.961

(57) ABSTRACT

Device for transmitting a rotating movement from movement generating means to a driven shaft, comprising at least one friction coupling and at least one induction coupling, arranged between said movement generating means and the driven shaft and coaxial with each other, said induction coupling being arranged on a middle diameter greater than the middle diameter on which the friction coupling is arranged.

The present invention relates to a device for controlling the means for recirculating an engine cooling fluid, in particular for vehicles.

It is known in the sector relating to the production of engines, in particular internal-combustion engines, that there exists the need to cool said engines by recirculating a cooling fluid moved by means of a corresponding recirculating pump, the impeller of which is made to rotate by a shaft actuated by the pulley and by a belt connected to the driving shaft.

It is also known that recirculation of the cooling fluid must be performed at a rate corresponding to the actual cooling requirement determined by the real conditions of use and by the external temperature so as to avoid the constant and needless rotation, at full speed, of devices which draw useful power and which in so doing increase the wear of the various component parts and the consumption levels of the vehicle.

It is also known that, in order to solve this problem, friction clutch and parasitic-current coupling devices have been proposed, these devices being able to produce two different speeds of rotation—i.e. full speed and a slower speed—of the pump shaft.

Examples of these devices are known, for example, from DE 101 58 732 and EP 1,353,051.

Although fulfilling their function, these devices have, however, certain drawbacks which limit the possibilities for application thereof; firstly, although having small axial dimensions, they envisage a magnetic induction coupling for the slower speed which is unable to achieve high values for the torque to be transmitted to the pump shaft, making the device unsuitable for high-performance pumps such as those used in heavy vehicles, in particular vehicles of the type which have engines operating at a low number of revolutions and pumps operating at high speed.

The second drawback, instead, relates to their radial dimensions which, being greater than the dimensions of the friction coupling of the rotor—said rotor normally being incorporated in the pulley connected to the driving shaft—create problems with regard to housing the pumps inside the various engine compartments of the vehicle.

The technical problem which is posed, therefore, is that of providing a device for controlling the means for recirculating engine cooling fluids for vehicles and the like, which is able to produce a variation in the speed of rotation of the impeller of said recirculating means in relation to the actual operating requirement of the engine.

Within the scope of this problem it is also required that this device should have small radial and axial dimensions, but at the same time should be able to produce high torques also at a slower speed of rotation of the engine so as to be applicable also to the high-performance pumps of heavy vehicles with low-speed engines.

It is also required that this device should be easy and inexpensive to produce and assemble and should be able to be installed easily on the pump body without the need for special adaptation.

These results are obtained according to the present invention by a device for transmitting a rotating movement from movement generating means to a driven shaft, comprising at least one friction coupling and at least one induction coupling arranged between said movement generating means and the driven shaft and coaxial with each other, said induction coupling being arranged on a middle diameter greater than the middle diameter on which the friction coupling is arranged.

Further details may be obtained from the following description of a non-limiting example of embodiment of the subject of the present invention, provided with reference to the accompanying drawings, in which:

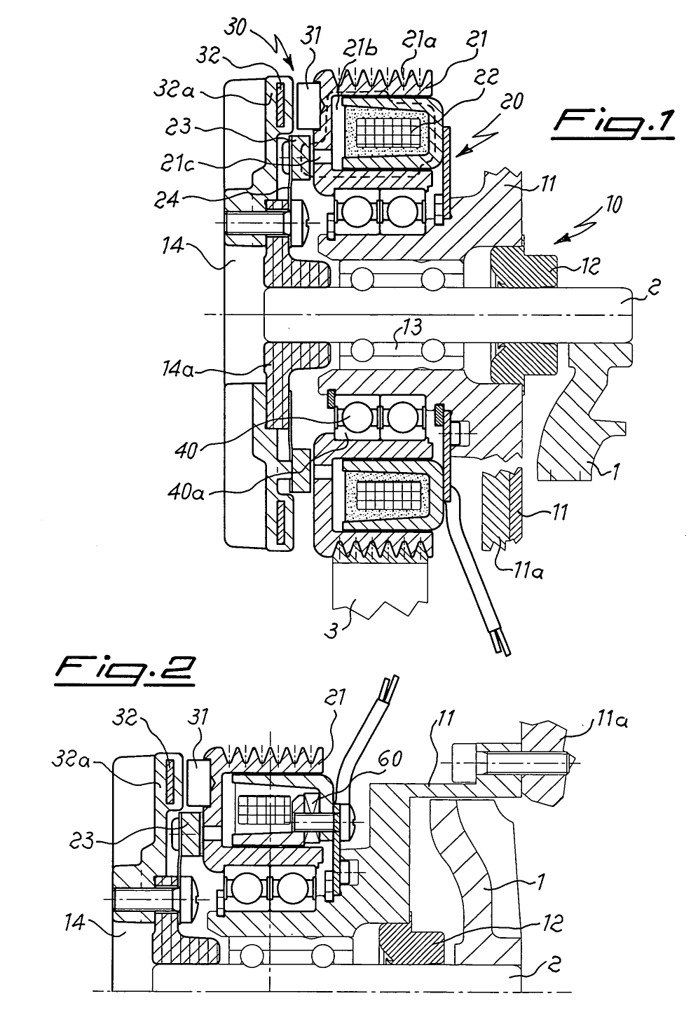

FIG. 1 shows a partially sectioned view of an example of embodiment of the device according to the present invention;

FIG. 2 shows a partially sectioned view, similar to that of FIG. 1, of a second example of embodiment of the device according to the present invention.

As shown in FIG. 1, the impeller 1 of a pump for recirculating the cooling fluid of vehicles and the like is mounted on a first end of a shaft 2 supported by a stationary assembly 10 comprising the body 11 of the pump fixed to the base 11a of the vehicle engine.

The pump body 11 has, arranged inside it, a seal 12 coaxial with the shaft 2 and a bearing 13 on the inner race of which the shaft 2 of the impeller is keyed.

A second bearing 40 is keyed onto the outside of the pump body 11, the outer race 40a of said bearing being integral with a circular ring 21 which has, suitably formed on its outer circumferential edge, a pulley 21a which is suitable for engagement with a belt 3 for transmission of the movement to the ring 21.

Since the pulling force of the belt 3 is transmitted onto the outer bearing 40, it is possible to limit the size of the inner bearing 13 which is not subject to dynamic loads, thus resulting in advantages in terms of the wear and limitation of the overall dimensions.

The circular ring 21 forms the rotor of an electromagnetic coupling 20 which comprises a fixed electromagnet 22 housed inside a corresponding seat of the rotor 21 and an armature 23, made of friction material, arranged facing the rotor 21 on the opposite side of the electromagnet and integral with a resilient membrane 24 which is in turn constrained to a driven element consisting of a fan 14 mounted on the shaft 2 by means of a corresponding sleeve 14a.

With this coupling system, the armature 23 is able to perform movements in the axial direction towards/away from the rotor 21, but is locked as regards relative rotation with respect to the fan 14.

The rotor 21 also has, arranged thereon, small magnets 31 which form the first part of a second Foucault current induction coupling 30, the other part of which is formed by a magnetizable element 32 which is mounted on a conductive support 32a integral with the driven fan 14, so as to be positioned axially facing the said permanent magnets 31 with a predetermined air gap.

The rotor part 21 supporting the magnets 31 has interruptions 21c in the magnetic conductivity of the rotor so as to produce a suitable annular closure of the magnetic flux lines as shown in FIG. 1.

The pump actuating device operates in a conventional manner:

when the electromagnet 22 is in the excited condition, the armature 23 is attracted towards the rotor 21 with which it engages axially, transmitting the movement of the rotor to the driven element fan 14/shaft 2 which therefore rotates at the same speed as the pulley 21a;

when the electromagnet 22 is in the non-energized condition, the Foucault current coupling 30 causes a rotation of the driven part fan 14/shaft 2 at a slower speed than that of the rotor 21 owing to the relative slipping of the rotor 21 and fan 14.

It can therefore be seen how with the device according to the invention it is possible to obtain operation of rotating devices such as water pumps for recirculating the cooling fluid of vehicles, which is particularly effective since the arrangement of the Foucault current coupling 30 on a middle diameter greater than that of the armature 23 of the friction coupling enables a greater torque to be transmitted to the driven element, while maintaining compact radial dimensions both of the armature 23 and of the rotor 21.

In particular, the overall diametral dimensions of the two engaging couplings 20 and 30 may be kept within the maximum diametral dimensions of the rotor 21 and hence the pulley 21a.

Owing to this limitation in the radial dimensions, together with the arrangement of the armature 23 outside the rotor 21 in the axial direction, it is possible to obtain a pulley 21a with a reduced diameter and a consequent multiplication of the number of revolutions transmitted by the belt 3, thereby making the device, and thus the pump, suitable also for vehicles with engines which operate at a low number of revolutions, but require a high speed of rotation of the cooling pump and a high transmission of torque via the friction coupling even though the latter uses a surface area of the driven armature/rotor part which is smaller than the rotor surface area used for the induction coupling.

In addition to this, the fact of having the armature 23 separate from the coupling 30 improves the operating conditions of the latter since dangerous contact between the magnets integral with the rotor and the support of the magnetizable elements 32 is avoided in the event of wear of the said armature.

FIG. 2 shows a second embodiment of the device according to the present invention which has in this case a permanent magnet 60 arranged on the fixed support of the electromagnet 22.

In this configuration the armature 23 is constantly recalled against the rotor 21 by the magnet 60, while excitation of the electromagnet 22, suitably controlled, cancels out the effect of the magnet 60 with consequent separation of the armature 23 from the rotor 21; in these conditions the induction coupling intervenes again and drives the armature 23 at a slower speed 30.

The presence of the permanent magnet 60 ensures that, in the event of an electrical fault, the armature is always engaged with the rotor, ensuring recirculation of the cooling fluid (fail safe system).

1. A device for transmitting a rotating movement from movement generating means to a driven shaft, comprising at least one friction coupling and at least one induction coupling, arranged between said movement generating means and the driven shaft and coaxial with each other, wherein said induction coupling is arranged on a middle diameter greater than the middle diameter on which the friction coupling is arranged.

2. The device according to claim 1, wherein said movement generating means consist of a suitably shaped circular ring having, formed on its outer circumferential edge, a pulley suitable for engagement with a corresponding belt.

3. The device according to claim 2, wherein the maximum diameter of the induction coupling is not greater than the maximum diameter of the circular ring generating the movement.

4. The device according to claim 3, wherein said circular ring generating the movement is mounted on a bearing keyed onto the stationary body supporting the driven shaft.

5. The device according to claim 1, wherein a circular flange axially facing the movement generating ring is mounted on said driven shaft.

6. The device according to claim 5, wherein said circular flange is a fan.

7. The device according to claim 1, wherein said friction coupling is of the electromagnetic type.

8. The device according to claim 7, wherein said friction coupling comprises a fixed electromagnet and an armature arranged on opposite side of the movement generating ring in the axial direction.

9. The device according to claim 8, wherein said armature is integrally joined to the driven shaft by means of a resilient membrane able to allow movements in the axial direction towards/away from the rotor and prevent the relative rotation of the armature with respect to the driven shaft.

10. The device according to claim 8, wherein said armature is integrally joined to a circular flange mounted on the driven shaft.

11. The device according to claim 8, wherein the contact surface area between said armature and the movement generating ring is smaller than the surface area of the ring corresponding to the induction coupling.

12. The device according to claim 1, wherein the induction coupling comprises a plurality of permanent magnets which are integral with the movement generating element and at least one magnetizable element integral with the flange of the driven shaft.

13. The device according to claim 12, wherein said magnetizable element is inserted inside a conductive support integral with the circular flange of the driven shaft.

14. The device according to claim 1, wherein said driven shaft is the shaft actuating the impeller of a recirculating pump.

15. The device according to claim 14, wherein said recirculating pump is the pump for the cooling fluid of a vehicle.

16. A pump for recirculating a cooling fluid, comprising a device for transmitting the rotating movement from movement generating means to the driven shaft of the pump and provided with at least one friction coupling and at least one induction coupling arranged between said movement generating means and the driven shaft and coaxial with each other, wherein said induction coupling is arranged on a middle diameter greater than the middle diameter on which the friction coupling is arranged.
